(19) United States
(12) Patent Application Publication
(10) Pub. No.: US 2023/0092197 A1
(43) Pub. Date: Mar. 23, 2023

(54) FAT COMPOSITION SUITABLE AS A COCOA BUTTER EQUIVALENT

(71) Applicant: AAK AB (publ), Malmö (SE)

(72) Inventor: Bjarne JUUL, Højbjerg (DK)

(21) Appl. No.: 17/800,746

(22) PCT Filed: Feb. 11, 2021
(86) PCT No.: PCT/SE2021/050101

§ 371 Date: Aug. 18, 2022

(30) Foreign Application Priority Data
Feb. 20, 2020 (SE) 2050191-2

(51) Int. Cl. A23D 9/04; A23G 1/38

(52) U.S. Cl. CPC A23D 9/04; A23G 1/38; A23V 2002/00

(57) ABSTRACT

The present invention relates to a fat composition suitable for use as a cocoa butter equivalent, wherein the fat compo-sition comprises triglycerides of which 60% by weight or more is Sat₂O, wherein Sat is selected from St, P, or combinations hereof; and wherein, in the fat composition, the content of St₂O is 40% by weight or less, and the total content of StOP+StPO+St₂O is 60% by weight or less, wherein O is oleic acid, St is stearic acid, and P is palmitic acid; and wherein the fat composition has a Buhler crystallization index (BCI) value of 2.5 or more. Uses of the fat composition are also disclosed.

### TECHNICAL FIELD OF THE INVENTION

The present invention relates to a fat composition suitable for use as a cocoa butter equivalent, preferably characterized by having a Bühler crystallization index (BCI) value equal to or above 2.5.

The present invention also relates to uses of the fat composition.

### BACKGROUND OF THE INVENTION

An important production parameter of chocolate is its ability to crystallize fast in a stabile crystal form. The ability of a cocoa butter to add that ability to a chocolate is often evaluated by the so-called bühler Crystallisation Index, BCI. The obtained BCI value is used in the chocolate and fat industry to predict the crystallization behavior of cocoa butter in a fast way. It is an empirical value, and a value above 3.5 is widely accepted as a good quality cocoa butter regarding crystallization behavior. Thus, the BCI value is an empirical value known in the art.

In chocolate manufacturing, cocoa butter may be fully or partially replaced by Cocoa Butter Equivalents (CBEs), which are often produced by mixing a vegetable fat with a high content of StOSt (more than 30%) and a vegetable fat with a high content of POP (more than 40%) in a ratio, such as from 20:80 to 80:20. The BCI value of a Cocoa Butter Equivalent (CBE) that replaces cocoa butter 1:1 on other physical parameters is often below 2.5 and accordingly has a BCI value, which is significantly lower than the BCI value of cocoa butter. There is thus a need in the art for a fat composition suitable for use as a CBE with similar physical properties as cocoa butter and having a BCI value above 2.5. Accordingly, the main object of the invention is to provide such a CBE.

### SUMMARY OF THE INVENTION

The present invention relates to a fat composition suitable for use as a cocoa butter equivalent (CBE), wherein the fat composition comprises triglycerides of which 60% by weight or more is Sat₂O, wherein Sat is selected from St, P, or combinations hereof; and wherein, in the fat composition, the content of St₂O is 40% by weight or less, and the total content of StOP+StPO+St2O is 60% by weight or less, wherein O is oleic acid, St is stearic acid, and P is palmitic acid; and wherein the fat composition has a Buhler crystallization index (BCI) value of 2.5 or more.

In one embodiment, the present invention relates to a fat composition suitable for use as a CBE, preferably with a BCI value of 2.5 or more, wherein the fat composition comprises between 20 and 80% by weight of a vegetable fat composition, wherein the vegetable fat composition comprises triglycerides of which at least 60% by weight is Sat₂O, and wherein, in the vegetable fat composition, the ratio of SatOSat/SatSatO is 12 or more, and the POP content is between 25 and 95% by weight.

Altogether, the fat composition according to the present invention is suitable for use as a CBE characterized by having a BCI value equal to or above 2.5, which is a BCI value that better resembles the BCI value of cocoa butter. This is a quality that has been sought after in the art.

The present invention further relates to the use of a fat composition suitable for use as a cocoa butter equivalent (CBE), wherein the fat composition comprises triglycerides of which 60% by weight or more is Sat₂O, wherein Sat is selected from St, P, or combinations hereof; and wherein, in the fat composition, the content of St₂O is 40% by weight or less, and the total content of StOP+StPO+St2o is 60% by weight or less, wherein O is oleic acid, St is stearic acid, and P is palmitic acid; and wherein the fat composition has a Buhler crystallization index (BCI) value of 2.5 or more in the manufacture of a food product for human consumption.

The present invention also relates to the use of a fat composition suitable for use as a cocoa butter equivalent (CBE), wherein the fat composition comprises triglycerides of which 60% by weight or more is Sat₂O, wherein Sat is selected from St, P, or combinations hereof; and wherein, in the fat composition, the content of St₂O is 40% by weight or less, and the total content of StOP +StPO +St2O is 60% by weight or less, wherein O is oleic acid, St is stearic acid, and P is palmitic acid; and wherein the fat composition has a Buhler crystallization index (BCI) value of 2.5 or more, as an ingredient in a food product, such as a confectionary product, such as a chocolate or chocolate-like product or filling.

Definitions

In the context of the present invention, the following terms are meant to comprise the following, unless defined elsewhere in the description.

The terms “about”, “around”, or “approximately” are meant to indicate e.g. the measuring uncertainty commonly experienced in the art, which can be in the order of magnitude of e.g. +/−1, 2, 5, 10%, etc.

The term “comprising” or “to comprise” is to be interpreted as specifying the presence of the stated parts, steps, features, or components, but does not exclude the presence of one or more additional parts, steps, features, or components.

The terms “oils” and “fats” are used for esters between fatty acids and glycerol. One molecule of glycerol can be esterified to one, two, and tree fatty acid molecules resulting in a monoglyceride (MAG), a diglyceride (DAG), or a triglyceride (TAG), respectively. Usually fats consist of mainly triglycerides and minor amounts of lecithin, sterols, etc. If the fat is liquid at room temperature, it is normally called oil. If the fat is semisolid at room temperature and of exotic origin it is referred to as butter, e.g. shea butter. If it is solid at room temperature, it is called a fat.

As used herein, “vegetable oil” and “vegetable fat” is used interchangeably, unless otherwise specified. As used herein, the term “vegetable” shall be understood as originating from a plant retaining its original chemical structure/composition. Thus, vegetable fats or vegetable triglycerides are still to be understood as vegetable fats or vegetable triglycerides after fractionation etc. as long as the chemical structure of the fat components or the triglycerides are not altered. When vegetable triglycerides are for example transesterified they are no longer to be understood as a vegetable triglyceride in the present context.

With respect to oils, fats, and related products in this context, reference is made to “Physical and Chemical Characteristics of Oils, Fats and Waxes”, AOCS, 1996, as well as “Lipid Glossary 2”, F. D. Gunstone, The Oily Press, 2004.

Sat means a saturated fatty acid, and U means an unsaturated fatty acid. The fatty acids, which are comprised in the triglycerides of formulae Sat₂U, SatUSat, etc., may be identical, or different, saturated and unsaturated fatty acids. Specifically, in the present invention Sat is selected from C16:0 and/or C18:0 saturated fatty acids.

St means stearic acid/stearate (C18:0), O means oleic acid/oleate (C:18:1), P means palmitic acid (C16:0).

As used herein, the term “triglycerides” may be used interchangeably with the term “triacylglycerides” and should be understood as an ester derived from glycerol and three fatty acids. “Triglycerides” may be abbreviated TG or TAG.

The % amount of a triglyceride (TAG) is determined using the AOCS Ce 5b-89 method which is a standard method for determining triglycerides in vegetable oils by HPLC. This method does not distinguish the different positional isomers of a given TAG, thus e.g. PPO and POP are measured as one.

In the embodiments where there is a need for determining the individual positional isomers (such as the determination of the SatOSat/SatSatO ratio) the skilled person will know a method for determining positional isomers for example by High Performance Liquid Chromatography (HPLC) in combination with an Evaporative Light Scattering Detector (ELSD). The sample preparation consists of an epoxidation of the double bonds of unsaturated fatty acids. Alternatively, the ratio can be determined by means of High Performance Liquid Chromatography (HPLC) on Silver Ion columns and detected by ELSD. These methods are known and suitable methods are available at commercial laboratories, such as Reading Scientific Services Ltd. and Mylnefield Lipid Analysis.

As used herein “% by weight” relates to weight percentage i.e. wt %, wt. % or wt.-%. The given weight amounts in the fat composition is calculated from a composition containing approximately 100% triglycerides, however compositions containing up to 10 wt % minor components like free fatty acids, mono- and/or diglycerides may also be included.

By the ratio SatOSat/SatSatO is meant that the total weight (the sum) of all SatOSat TAGs is divided by the total weight (the sum) of all SatSatO TAGs.

As used herein a “chocolate” is to be understood as a chocolate and/or chocolate-like product. By a chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like products may be produced with a low amount of or even without cocoa butter, e.g. by replacing the cocoa butter with a cocoa butter equivalent, cocoa butter substitute, etc. In addition, many chocolate products comprise cocoa powder or cocoa mass, although some chocolate products, such as typical white chocolates, may be produced without cocoa powder, but e.g. drawing its chocolate taste from cocoa butter. Depending on the country and/or region there may be various restrictions on which products may be marketed as chocolate.

The chocolate can also be a chocolate comprising milk fat, however without being labelled as “milk chocolate”. The European legislation states that in order for a chocolate to be labelled as a milk chocolate it should comprise a minimum of 3.5% by weight milk fat compared to the weight of the total chocolate recipe, which corresponds to 7-14% by weight of a standard chocolate's fat composition depending on fat content.

As used herein “cocoa butter equivalent” or CBE is intended to mean an edible fat having very similar chemical and physical properties to, and being compatible with, cocoa butter (CB). In both CB and CBEs, the main fatty acids are typically palmitic acid, stearic acid, and oleic acids. The triglycerides are typically 2-oleo di-saturated (Sat₂O). Cocoa butter equivalents are e.g. made from a mix of a palm mid fraction and a stearin fraction of shea stearin or another oil fraction rich in SatOSat triglycerides, where Sat is a saturated fatty acid having a chain length of C16 or longer, such as C16 and/or C18.

“Texture” refers to the properties held in consistency and sensations caused by the external surface of an object. Characterization of texture commonly falls in two main groups, where the first group is based on sensory analysis performed by a panel of trained evaluators and the second group is based on an instrumental method of analysis.

Sensory analysis includes use of the fingers, as well as the lips and the tongue and teeth in the mouth of the trained evaluator. The widely used instrumental method is a cone or needle penetration test. Automatic analyzer equipment used is normally referred to as a texture analyzer.

The Texture Analyzer used in the present invention is a Texture Analyzer TA-XT2i, and the probe used is the P2N needle set to penetrate 5 mm. The measured penetration force is expressed in grams.

“Food products” comprise products for human consumption. Important groups of products are those where cocoa butter and cocoa butter-like fats are used.

For products and methods in the confectionery areas, reference is made to “Chocolate, Cocoa and Confectionery”, B. W. Minifie, Aspen Publishers Inc., 3. Edition 1999.

Palm Mid Fraction (PMF) is produced by multiple fractionation of palm oil. Its main characteristic is a very high content in symmetrical di-saturated triglycerides (mainly POP). In the present disclosure Palm Mid Fraction and PMF is used interchangeably.

### DETAILED DESCRIPTION OF THE INVENTION

The present invention relates to a fat composition suitable for use as a cocoa butter equivalent, wherein the fat composition comprises triglycerides of which 60% by weight or more is Sat₂O, wherein Sat is selected from St, P, or combinations hereof; and wherein, in the fat composition, the content of St₂O is 40% by weight or less, and the total content of StOP+StPO+St₂O is 60% by weight or less, wherein O is oleic acid, St is stearic acid, and P is palmitic acid; and wherein the fat composition has a Bühler crystallization index (BCI) value of 2.5 or more.

The BCI value is an empirically value calculated based on a controlled cooling rate measured for example on a MultiTherm TC produced by Bühler. The experience in the chocolate industry is that the BCI value of the cocoa butter correlate well with the general crystallisation properties of the chocolate, i.e. a higher BCI value indicates easier tempering, higher tempering capacity, and faster crystallisation.

Many chocolate producers use the value 3.5 as the minimum value, which they can accept for cocoa butter. CBEs have similar physical properties to cocoa butter, except for the fact that standard CBEs have a lower BCI value, often below 2.5. The present invention relates to a novel CBE with improved characteristics such as a BCI value equal to or above 2.5.

In one or more embodiments, the fat composition has a BCI value of at least 2.6, such as at least 2.7, such as at least 2.8, such as at least 2.9, such as at least 3.0, such as at least 3.2, such as at least 3.4, such as at least 3.6, such as at least 3.8, or such as at least 4.

In one or more embodiments, the fat composition has a BCI value between 2.5 and 6.0, such as between 3.0 and 5.0.

In one or more embodiments, the fat composition has a BCI value between 2.8 and 6.0, such as between 2.7 and 6.0, or such as between 3.0 and 6.0.

In one or more embodiments, the content of St₂O is 38% by weight or less.

In one or more embodiments, the content of St₂O is between 25 and 40% by weight, such as between 25 and 38% by weight, such as between 27 and 38% by weight, such as between 30 and 38% by weight, or such as between 32 and 38% by weight.

In one or more embodiments, the total content of StOP+StPO+St₂O is 55% by weight or less, such as 52% by weight or less, such as 50% by weight or less, or such as 45% by weight or less. The total content of StOP+StPO+St₂O by weight is calculated as the sum the weight of StOP, StPO, and St₂O, i.e. ΣStOP+StPO+St₂O triglycerides by weight.

In one or more embodiments, the total content of StOP+StPO+St₂O is between 25 and 60% by weight, such as between 25 and 55% by weight, such as between 25 and 52% by weight, such as between 25 and 50% by weight, such as between 27 and 52% by weight, or such as between 27 and 50% by weight.

In one or more embodiments, the fat composition further comprises a fat and/or an oil originating from cocoa, mango, shea, illipe, sal, kokum, or combinations hereof.

In one or more embodiments, the fat composition comprises between 20 and 80% by weight of a vegetable fat composition, wherein the vegetable fat composition comprises triglycerides of which at least 60% by weight is Sat₂O, and wherein, in the vegetable fat composition, the ratio of SatOSat/SatSatO is 12 or more, and the POP content is between 25 and 95% by weight.

In one or more embodiments, at least 50% by weight, such as at least 60% by weight of the triglycerides in the vegetable fat composition is Sat₂O.

In one or more embodiments, the vegetable fat composition comprises triglycerides of which from 50 to 95% by weight is Sat₂O, such as from 50 to 90% by weight, such as from 55 to 90% by weight, such as from 55 to 85% by weight, such as from 60 to 85% by weight, or such as from 60 to 80% by weight.

In one or more embodiments, the ratio of SatOSat/SatSatO is at least 14, such as at least 15, such as at least 16, such as at least 17, such as at least 18, such as at least 20, such as at least 21, such as at least 22, such as at least 23, such as at least 24, or such as at least 25.

In one or more embodiments, the ratio of SatOSat/SatSatO is between 12 and 50, such as from 14 to 50, such as from 15 to 50, such as from 16 to 50, such as from 17 to 50, such as from 18 to 50 or such as from 20 to 50, such as 21 to 50, such as 22 to 50, such as 23 to 50, such as 24 to 50, such as 25 to 50.

It was surprising how much effect a higher ratio in SatOSat/SatSatO effected the BCI value of a CBE and thus the tempering properties and the crystallization speed of the fat component.

In one or more embodiments, the POP content of the vegetable fat composition is from 30 to 95% by weight, such as from 30 to 90% by weight, such as from 30 to 80% by weight, such as from 40 to 75% by weight, or such as from 45 to 70% by weight.

In one or more embodiments, the POP content of the vegetable fat composition is from 30 to 95% by weight, such as from 30 to 90% by weight, such as from 30 to 80% by weight, such as from 30 to 75% by weight, or such as from 30 to 70% by weight.

In one or more embodiments, the POP content of the vegetable fat composition is from 40 to 95% by weight, such as from 40 to 90% by weight, such as from 40 to 80% by weight, such as from 40 to 75% by weight, or such as from 40 to 70% by weight.

In one or more embodiments, the POP content of the vegetable fat composition is from 45 to 95% by weight, such as from 45 to 90% by weight, such as from 45 to 80% by weight, such as from 45 to 75% by weight, or such as from 45 to 70% by weight.

In one or more embodiments, the POP content of the vegetable fat composition is from 35 to 75% by weight, such as from 40 to 75% by weight, such as from 45 to 75% by weight, or such as from 50 to 75% by weight.

In one or more embodiments, the POP content of the vegetable fat composition is from 35 to 70% by weight, such as from 40 to 70% by weight, such as from 45 to 70% by weight, or such as from 50 to 70% by weight.

In one or more embodiments, the vegetable fat composition comprises 2.9% by weight or less tri-saturated triglycerides, such as 2.0% by weight or less, such as 1.0% by weight or less, or such as 0.5% by weight or less.

The tri-saturated triglycerides is in one embodiment referring to the sum of all tri-saturated triglycerides containing only palmitic acid and stearic acid, i.e. ΣPPP, PPSt, PStP, PStSt, StPSt, and StStSt triglycerides.

In one or more embodiments, the total content of tri-saturated triglycerides in the vegetable fat composition is from 0.01 to 2.9% by weight, such as from 0.05 to 2.9% by weight, such as from 0.1 to 2.9% by weight, such as from 0.5 to 2.9% by weight, such as from 0.5 to 1.9% by weight, such as from 0.5 to 1.5%, or such as from 0.5 to 1.2% by weight.

The amount of tri-saturated TAGs in the vegetable fat composition is lower than in a standard polymorphic vegetable fat composition. It was surprising how much the content of tri-saturated TAGs in the fat component effected the BCI value of the CBE.

In one or more embodiments, the vegetable fat composition comprises monoglycerides (MAG) and diglycerides (DAG) in a total amount of 10% by weight or less, such as 8% by weight or less, such as 6% by weight or less, such as 5% by weight or less, or such as 4% by weight or less.

In one or more embodiments, the fat composition is a cocoa butter equivalent (CBE).

The fat composition of the present invention may contain up to 10% by weight of minor components like free fatty acids, mono- and/or diglycerides.

The present invention also relates to a fat composition as disclosed and described herein, wherein said fat composition is a CBE.

The present invention also relates to the use of a fat composition as disclosed and described herein in the manufacture of a food product for human consumption.

The present invention also relates to the use of a fat composition as disclosed and described herein as an ingredient in a food product.

The present invention also relates to the use of a fat composition as disclosed and described herein as an ingredient in a confectionary product.

The present invention also relates to the use of a fat composition as disclosed and described herein as an ingredient in a chocolate or chocolate-like product or filling.

The present invention also relates to the use of a fat composition as disclosed and described herein as a filling fat in a confectionary product.

The present invention also relates to the use of a fat composition as disclosed and described herein as a filling fat in a chocolate or chocolate-like product.

In one or more embodiments, the vegetable fat composition is mixed with an oil originating from mango, shea, illipe, sal, kokum, or combinations hereof, to manufacture the cocoa butter equivalent (CBE).

### EXAMPLES

### Example 1—Cocoa Butter Equivalent (CBE)

All used ingredients are from the same batch except the vegetable fats, which are specified in the below table 1.

Table 1 shows the composition of two fat components.

The standard fat component (Fat F) has a composition, which is quite normal for a Palm Mid Fraction, while the alternative fat component (Fat G) has a remarkable lower content of tri-saturated TAGs and a significant higher SatOSat/SatSatO ratio. The alternative fat (Fat G) used, is a modified standard PMF where a large part of the tri-saturated and a bit of the asymmetric mono-unsaturated TAGs were removed by an extra top fractionation.

TABLE 1

| | | Standard fat | Alternative fat |
|---|---|---|---|
| Method | Analysis | (Fat F) | (Fat G) |
| AOCS Ce 5b-89** | ΣU₃ | 1.1 | 0.9 |
| | ΣSatU₂ | 4.5 | 4.5 |
| | ΣSat₂U | 90.8 | 93.2 |
| | ΣSat₃ | 3.6 | 1.4 |
| AOCS Ce 5b-89** | POP | 64.9 | 64.7 |
| | POSt | 13.8 | 16.4 |
| | StOSt | 1.7 | 2.4 |
| * | SatOSat/SatSatO | 11.8 | 18 |

* The analysis can be done by any known method by a commercial laboratory.
**The % amount of a triglyceride (TAG) is determined using the AOCS Ce 5b-89 method, which is a standard method for determining triglycerides in vegetable oils by HPLC.

The two fat components (Fat F and Fat G) from table 1 are used to produce two simple standard CBEs by mixing the two fats with a Shea stearin IV 36 and an Illipe oil to get two comparable CBE's with about the same content of POP; POSt and StOSt (see table 2).

TABLE 2

| | | CBE | CBE |
|---|---|---|---|
| | | standard | alternative |
| | | fat F % | fat G % |
| Ingredients | | by weight | by weight |
| Standard fat (Fat F) | | 48.0 | 0.0 |
| Alternative fat (Fat G) | | 0.0 | 50.0 |
| Shea stearin IV 36 | | 48.0 | 50.0 |
| Illipe oil | | 4.0 | 0.0 |
| Method | Analysis | Percent | |
| AOCS Ce 5b-89** | ΣU₃ | 0.9 | 0.8 |
| | ΣSatU₂ | 5.7 | 5.8 |
| | ΣSat₂U | 90.7 | 91.9 |
| | ΣSat₃ | 2.7 | 1.5 |
| AOCS Ce 5b-89** | POP | 31.6 | 32.5 |
| | POSt | 11.8 | 12.2 |
| | StOSt | 36.3 | 36.1 |
| * | SatOSat/SatSatO | 25.9 | 33.3 |
| Bühler | BCI Value | 2.2 | 3.5 |
| crystallization | | | |
| index*** | | | |

* The analysis can be done by any known method by a commercial laboratory.
**The % amount of a triglyceride (TAG) is determined using the AOCS Ce 5b-89 method, which is a standard method for determining triglycerides in vegetable oils by HPLC.
***MultiTherm ™ T/TC instrument. The method is described of the Company Bühler who produce the instrument.

### Conclusion

Example 1 shows how it is possible to improve the BCI value for a cocoa butter equivalent (CBE) by using an alternative fat component of the invention with an increased ratio of SatOSat/SatSatO and a lower content of tri-saturated TAGs.

It can be concluded that a CBE with higher ratio of SatOSat/SatSatO and a lower content of tri-saturated TAGs provides a CBE with a significant higher BCI value, which correspond with a higher quality cocoa butter regarding BCI value in many chocolate producers' opinion and experience.

Higher quality is closely connected to easier tempering, higher tempering capacity, and a faster crystallization.

### Example 2—Cocoa Butter Equivalent (CBE)

The following example shows the same improvement in BCI value for CBE's with a higher POSt content.

The same fats as the ones shown in table 1 is used in this example, however mixed in another ratio (see table 3) to demonstrate the general effect on the BCI value of a CBE when changing from fat component F to fat component G. The two blends are adjusted to make comparable Sat₂O content.

TABLE 3

| | | CBE | CBE |
|---|---|---|---|
| | | standard | alternative |
| | | fat F % | fat G % |
| Ingredients | | by weight | by weight |
| Standard fat (Fat F) | | 38.0 | 0 |
| Alternative fat (Fat G) | | 0 | 40.0 |
| Shea stearin IV 36 | | 23.0 | 26.0 |
| Illipe oil | | 39.0 | 34.0 |
| Method | Analysis | Percent | |
| AOCS Ce 5b-89** | ΣU₃ | 1.0 | 0.8 |
| | ΣSatU₂ | 4.9 | 5.0 |
| | ΣSat₂U | 91.6 | 92.6 |
| | ΣSat₃ | 2.5 | 1.6 |
| AOCS Ce 5b-89** | POP | 27.8 | 28.9 |
| | POSt | 20.4 | 20.3 |
| | StOSt | 34.2 | 34.2 |
| * | SatOSat/SatSatO | 40.3 | 57.3 |
| Bühler | BCI Value | 2.0 | 2.6 |
| crystallization | | | |
| index*** | | | |

* The analysis can be done by any known method by a commercial laboratory.
**The % amount of a triglyceride (TAG) is determined using the AOCS Ce 5b-89 method, which is a standard method for determining triglycerides in vegetable oils by HPLC.
***MultiTherm ™ T/TC instrument. The method is described of the Company Bühler who produce the instrument.

### Conclusion

It can be concluded that using the alternative fat component (an alternative PMF), including a POSt rich CBE with a higher ratio of SatOSat/SatSatO and a lower content of tri-saturated TAGs, results in a CBE with a significant higher BCI value, which corresponds to a higher quality cocoa butter regarding BCI value in many chocolate producers' opinion and experience.

1-20. (canceled)

21. A fat composition comprising triglycerides of which 60% by weight or more is Sat₂O, wherein Sat is selected from the group consisting of St, P, and combinations hereof; and wherein, in the fat composition, the content of St₂O is 40% by weight or less, and the total content of StOP+StPO+St₂O is 60% by weight or less, wherein O is oleic acid, St is stearic acid, and P is palmitic acid; and wherein the fat composition has a Bühler crystallization index (BCI) value of 10 2.5 or more.

22. The fat composition according to claim 21, wherein the fat composition has a BCI value of at least 2.6.

23. The fat composition according to claim 21, wherein the fat composition has a BCI value between 2.5 and 6.0.

24. The fat composition according to claim 21, wherein the content of St₂O is 38% by weight or less.

25. The fat composition according to claim 21, wherein the content of St₂O is between 25 and 40% by weight.

26. The fat composition according to claim 21, wherein the 30 total content of StOP+StPO+St₂O is 55% by weight or less.

27. The fat composition according to claim 21, wherein the total content of StOP+StPO+St₂O is between 25 and 60% by weight.

28. The fat composition according to claim 21, wherein the fat composition further comprises a fat and/or an oil originating from the group consisting of cocoa, mango, shea, illipe, sal, kokum, and combinations hereof.

29. The fat composition according to claim 21, wherein the fat composition comprises between 20 and 80% by weight of a vegetable fat composition, wherein the vegetable fat composition comprises triglycerides of which at least 60% by weight is Sat₂O, and wherein, in the vegetable fat composition, the ratio of SatOSat/SatSatO is 12 or more, and the POP content is between 25 and 95% by weight.

30. The fat composition according to claim 29, wherein the vegetable fat composition comprises 2.9% by weight or less tri-saturated triglycerides.

31. The fat composition according to claim 29, wherein the ratio of SatOSat/SatSatO is at least 14.

32. The fat composition according to claim 29, wherein the total content of tri-saturated triglycerides in the vegetable fat composition is from 0.01 to 2.9% by weight.

33. The fat composition according to claim 29, wherein the vegetable fat composition comprises triglycerides of which from 50 to 95% by weight is Sat₂O.

34. The fat composition according to claim 29, wherein the POP content of the vegetable fat composition is from 30 to 95% by weight.

35. The fat composition according to claim 29, wherein the vegetable fat composition comprises monoglycerides (MAG) and diglycerides (DAG) in a total amount of 10% by weight or less.

36. The fat composition according to claim 21, wherein said fat composition is a cocoa butter equivalent (CBE).

37. A method of manufacturing a food product for humans, the method comprising the addition of a fat composition according to claim 21.

38. A food product comprising at least one fat composition according to claim 21.

39. The food product of claim 38, where the food product is a confectionary product.

40. The food product of claim 39, where the confectionary product is a chocolate or cholate like product or filling.
